(19) United States
(12) Patent Application Publication
(10) Pub. No.: US 2017/0337814 A1
(43) Pub. Date: Nov. 23, 2017

(54) SAFETY ALERTING DRIVERS DEVICE AND SYSTEM

(71) Applicants: Donald Edward Morgan, Jacksonville, FL (US); Hydie Morgan, Jacksonville, FL (US)

(72) Inventors: Donald Edward Morgan, Jacksonville, FL (US); Hydie Morgan, Jacksonville, FL (US)

(21) Appl. No.: 15/598,253

(22) Filed: May 17, 2017

Related U.S. Application Data
(60) Provisional application No. 62/339,534, filed on May 20, 2016.

(51) Int. Cl. G08G 1/087; G08G 1/0965

(52) U.S. Cl. CPC G08G 1/087; G08G 1/0965

(57) ABSTRACT

The present disclosure relates to a safety alerting device comprising a beacon; a transceiver for receiving information over one or more networks; and a traffic light communicator for communicating with one or more traffic lights; wherein the safety alerting device alters the illumination pattern of one or more traffic lights; wherein the beacon alerts individuals of emergency vehicles; wherein the beacon comprises a plurality of single-colored lights; wherein the beacon comprises a plurality of multi-colored lights; and wherein the beacon comprises an audible siren. The present disclosure further relates to a system for alerting comprising a beacon for alerting individuals of approaching emergency vehicles; a transceiver for receiving, from one or more sources, information relating to approaching emergency vehicles; and a traffic light communicator for altering the illumination pattern of one or more traffic lights.

### CROSS-REFERENCE TO RELATED APPLICATION(S)

The present application claims priority to U.S. Provisional Patent Application No. 32/339,534 filed on May 20, 2016, entitled “SAFETY LIGHT ALERTING DRIVERS DEVICE” the entire disclosure of which is incorporated by reference herein.

### BACKGROUND OF THE INVENTION

### 1. Field of the Invention

The present disclosure relates to the field of traffic signaling devices and, more specifically, traffic signaling devices that alert drivers of emergency vehicles approaching intersections.

### 2. Description of Related Art

Traffic signals are designed to eliminate vehicle collisions at intersections by only allowing unidirectional traffic to traverse a given intersection. Emergency vehicles such as police cars, ambulances, and fire trucks must also share the same roads but must also be given the right of way when traveling to an emergency to minimalize the possibility of injury or damage. Since emergency vehicles use the same roads as private drivers, they also generally travel in the same direction. This leads to the invariable situation where emergency vehicles responding to an emergency approach standing traffic from behind.

Under existing technology, emergency vehicles use flashing lights and sirens to alert traffic to the presence of an emergency vehicle and afford the drivers enough time to move out of the way. Unfortunately, drivers don't always notice the approaching emergency vehicles because they are not facing forward and cannot hear the sirens used. The flashing lights are difficult to notice in bright, daylight conditions, especially when a driver is not facing the direction of the on-coming emergency vehicle. Sirens can be easily go unnoticed if the driver has a hearing impairment or is listening to loud music. Further, even if a driver notices an approaching emergency vehicle, the driver may be prevented from moving out of the way by other cars in heavily congested areas.

Based on the foregoing, there is a need in the art for a system that alerts drivers facing away from an approaching emergency vehicle to move out of the way. Additionally, there is a need in the art for a system that allows emergency workers to manipulate traffic lights to clear congestion in and around busy intersections. Such a need has heretofore remained unsatisfied.

### SUMMARY OF THE INVENTION

In an exemplary embodiment of the present disclosure, the safety alerting device comprises a beacon; a transceiver for receiving information over one or more networks; and a traffic light communicator for communicating with one or more traffic lights. In one embodiment, the safety alerting device alters the illumination pattern of one or more traffic lights. In another embodiment, the beacon alerts individuals of emergency vehicles. In another embodiment, the beacon comprises a plurality of single-colored lights. In another embodiment, the beacon comprises a plurality of multi-colored lights. In another embodiment, the beacon comprises an audible siren.

In another exemplary embodiment of the preset disclosure, the safety alerting device may comprise a power cell. In one embodiment, the power cell comprises a solar panel or photovoltaic panel used to power the safety alerting device. In another embodiment, the power cell is removable. In another embodiment, the power cell is user-positionable.

In another exemplary embodiment of the preset disclosure, the transceiver is operable for sending information over one or more networks.

In another exemplary embodiment of the preset disclosure, the safety alerting device may comprise a vehicle transmitter for transmitting information to the safety alerting device over one or more networks.

In another exemplary embodiment of the preset disclosure, the safety alerting device may comprise a vehicle transmitter that is operable for transmitting an authentication token. In another embodiment, the safety alerting device is operable for authenticating the authentication token before accepting information.

In another exemplary embodiment of the preset disclosure, the safety alerting device may comprise a vehicle display that displays relevant traffic information to vehicle operators.

In another exemplary embodiment of the preset disclosure, the transceiver sends information to and receives information from a server over one or more networks.

In another exemplary embodiment of the preset disclosure, the safety alerting device may comprise a user mobile device for sending and receiving information over one or more networks comprising a mobile device display. In another embodiment, an app is loaded on the user mobile device. In another embodiment, the user mobile device is operable for receiving information from the transceiver. In another embodiment, the app causes the user mobile device to display an alert on the mobile device display.

In another exemplary embodiment of the preset disclosure, the safety alerting device may comprise a beacon for alerting individuals of approaching emergency vehicles. In another embodiment, the safety alerting device may comprise a transceiver for receiving, from one or more sources, information relating to approaching emergency vehicles. In another embodiment, the safety alerting device may comprise a traffic light communicator for altering the illumination pattern of one or more traffic lights.

In another exemplary embodiment of the preset disclosure, the transceiver is operable for sending information over one or more networks.

In another exemplary embodiment of the preset disclosure, the safety alerting device may comprise a server. In one embodiment, the server is operable for receiving information from the transceiver, over one or more networks. In another embodiment, the server is operable for sending information to the transceiver, over one or more networks.

In another exemplary embodiment of the preset disclosure, the safety alerting device may calculate a vehicle route.

In another exemplary embodiment of the preset disclosure, the safety alerting device may receive information relating to traffic conditions. In another embodiment, the safety alerting device may calculate a vehicle route.

In another exemplary embodiment of the preset disclosure, the safety alerting device may comprise a user mobile device for sending and receiving information over one or more networks comprising a mobile device display. In another embodiment, the system may comprise an app loaded on the user mobile device. In another embodiment, the user mobile device is operable for receiving information from the transceiver. In another embodiment, the app causes the user mobile device to display an alert on the mobile device display.

In another exemplary embodiment of the preset disclosure, the safety alerting device may comprise a vehicle transmitter operable for sending information over one or more networks.

In another exemplary embodiment of the preset disclosure, the vehicle transmitter comprises an authentication token.

In another exemplary embodiment of the preset disclosure, the system may authenticate an authentication token. In another embodiment, the transceiver connects to the vehicle transmitter if the authentication token is authenticated. In another embodiment, the transceiver disconnects from the vehicle transmitter if the authentication is not authenticated.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flow chart diagram of the safety alerting device and system, according to an embodiment of the present invention.

FIG. 2 is an exploded isometric view of an exemplary safety alerting device, according to an embodiment of the present invention.

FIG. 3 is an frontal view of an exemplary safety alerting device installed onto a traffic light, according to an embodiment of the present invention.

FIG. 4 is an elevated isometric view of an exemplary transmitter, according to an embodiment of the present invention.

FIG. 5 is an exemplary schematic diagram of an exemplary transmitter, according to an embodiment of the present invention.

FIG. 6 is a flow chart diagram of the safety light alerting driver's device and system, according to an embodiment of the present invention.

### DETAILED DESCRIPTION OF PREFERRED EMBODIMENTS

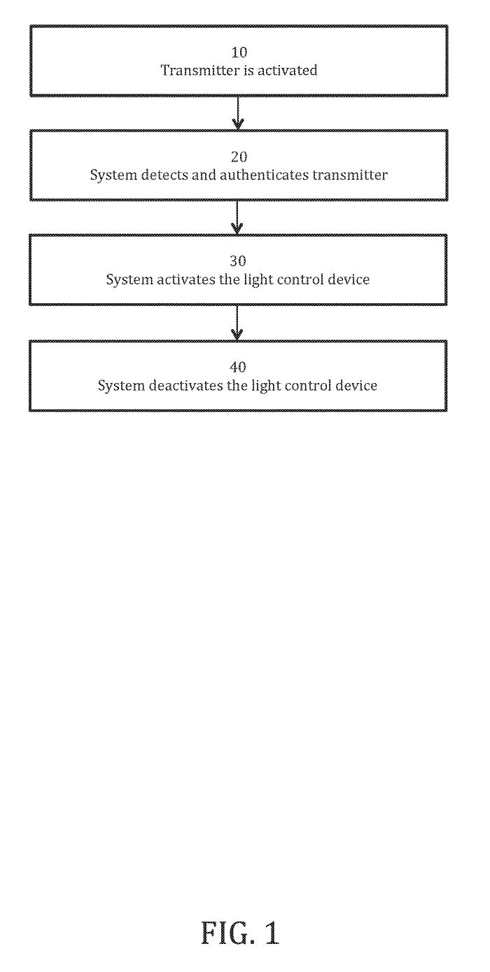

Preferred embodiments of the present invention and their advantages may be understood by referring to FIGS. 1-6, wherein like reference numerals refer to like elements.

In an exemplary embodiment of the present disclosure, the system comprises a safety alerting device. The safety alerting device may comprise a controller, a memory storage device, one or more beacons, one or more audio indicators, and a transceiver capable or sending or receiving information over one or more wired or wireless networks. The safety alerting device may be configured to be attached directly existing traffic signals, to preexisting poles or other mounts used by existing traffic signals, or to mount onto a newly installed pole, arm or other structural member. In one embodiment, the safety alerting device comprises a weather-resistant or a weather-proof chassis. In another embodiment, the system comprises a plurality of safety alerting devices that are configured to communicate with each other over one or more wired or wireless networks. In another embodiment, the safety alerting device may be configured to with a power cell that allows it to operate for an extended period should the power to the unit be interrupted. In another embodiment, the safety alerting device comprises a configurable solar or photovoltaic cell allowing it to recharge the internal power cell using solar energy.

In another exemplary embodiment of the present disclosure, the system comprises a plurality of safety alerting device that may be connected to existing traffic lights. In one embodiment, the safety alerting device, once installed, is connected to a traffic light such that the safety alerting device may alter the traffic light's illumination. In such an embodiment, once activated, the safety alerting device may override the traffic light's functionality such that it may cause the traffic light to signal red lights in all directions. In another embodiment, the safety alerting device may cause the attached traffic light to indicate green in a particular direction such that traffic in a given direction is cleared from the intersection.

In another exemplary embodiment of the present disclosure, the safety alerting device comprises a beacon. In one embodiment, the beacon comprises one or more mono- or multi-colored lights. Once activated, the safety alerting device may activate the beacon to alert nearby people that an emergency vehicle is approaching the intersection, thereby allotting sufficient time to clear an intersection.

In another exemplary embodiment of the present disclosure and with reference to FIG. 1, in step 10, a transmitter is activated. In one embodiment, the transmitter comprises a device installed in an emergency vehicle capable of transmitting a signal over one or more wired or wireless networks. In another embodiment, the transmitter comprises a low-frequency transmitter capable of transmitting a signal. In another embodiment, the emergency vehicle operator may manually activate the transmitter. In another embodiment, the transmitter may be automatically activated when the emergency vehicle operator activates the vehicle's lights or sirens. In another embodiment the transmitter may be activated remotely by receiving a signal transmitted by the system. In another embodiment, the transmitter, once activated, broadcasts a signal in all directions. In another embodiment, the transmitter broadcasts a signal in the direction the emergency vehicle is traveling.

In another exemplary embodiment of the present disclosure and with reference to FIG. 1, in step 20, the system detects and authenticates signals broadcasted by the transmitter. In one embodiment, the transmitter broadcasts a signal comprising an authentication token. In one embodiment, the authentication token may comprise a hashed string of characters the system uses to determine if the signal received emanated from a genuine transmitter. In another embodiment, the authentication token comprises the transmitter's identifying information including the make, model, serial number, manufacture date, and a unit identifier. In another embodiment, the authentication token comprises a hashed string of characters containing the transmitter's identifying information. In another embodiment, the transmitter's identifying information is static. In another embodiment, the transmitter's identifying information is dynamic. In another embodiment, after the transmitter is authenticated, the system may activate a safety alerting device. In another embodiment, if the transmitter fails authentication, the system may reject the transmitter and prevent it from connecting with the system. In another embodiment, the system records and stores transmitter identifying information relating to transmitters whose connections has been rejected. The system may use this information to determine whether to establish a future connection with a transmitter.

In another exemplary embodiment of the present disclosure and with reference to FIG. 1, in step 30, the system activates the safety alerting device. In one embodiment, the system comprises a safety alerting device attached to each traffic light at an intersection. In such an embodiment, all safety alerting devices communicate with each other over one or more wired or wireless networks. In another embodiment, the system comprises a single safety alerting device with connectivity to all traffic lights in an intersection. In such an embodiment, the safety alerting device may control all traffic lights independent of one another. In another embodiment, the safety alerting device comprises a beacon that alerts near by individuals that an emergency vehicle is approaching the intersection. In one embodiment, the beacon comprises one or more mono-colored lights. In another embodiment, the beacon comprises one or more multi-colored lights. In another embodiment, the system comprises an audio indicator. The audio indicator may emit mono- or multi-tonal sound that indicates that an emergency vehicle is approaching the intersection to near by people. In another embodiment, the system may comprise one or more safety alerting devices installed locally at a particular intersection. In another embodiment, the system may comprise one or more safety alerting devices that may be stored remotely. In such an embodiment, the remotely-located safety alerting devices are configured to communicate with traffic lights over one or more wired or wireless networks.

In another embodiment of the present disclosure, once activated, the system may cause all traffic lights in an intersection to display red lights so that traffic will not enter the intersection. In another embodiment, once activated, the system may activate the beacon comprising one or more lights. In another embodiment, the beacon comprises a lighted sign with words or figures indicative of emergency vehicles. In such an embodiment, for example, the beacon may comprise the words “EMERGENCY VEHICLE APPROACHING,” or “CLEAR INTERSECTION.” In another embodiment, once activated, the system may cause the traffic lights to direct traffic to continue in the direction the emergency vehicle is moving. For example, if a north-bound emergency vehicle approaches an intersection comprising an east-west street, the system may cause the traffic directing east-bound, west-bound, and south-bound traffic to stop while directing the north-bound traffic to proceed north. The system may direct north-bound traffic to continue north to alleviate north-bound traffic congestion thereby allowing the emergency vehicle to proceed north unimpeded. In another embodiment, the system may calculate the emergency vehicle's path of travel and activate safety alerting devices along that route. In such an embodiment, the system may comprise a visual readout that displays the protected route to the emergency vehicle's driver. In another embodiment, the emergency vehicle's driver may specify a particular route to be protected by one or more safety alerting devices. In another embodiment, the transmitter may be detected by multiple safety alerting devices located at multiple intersections. In such an embodiment, the system may activate one or more of the safety alerting devices detecting the transmitter. In another exemplary embodiment, the safety alerting device, once activated, may also emit a signal to be detected by other mobile devices. In such an embodiment, the safety alerting device may emit a signal that is detected by other mobile devices within a pre-determined range. When those mobile devices detect the signal emitted by the safety alerting device, the device alert their owners to the eminent presence of an emergency vehicle, thereby allowing those people to clear the intersection before the emergency vehicle arrives at the intersection.

In another exemplary embodiment of the present disclosure and with reference to FIG. 1, in step 40, the system deactivates the light control device after the emergency vehicle exits the intersection. In one embodiment, the system automatically deactivates the light control device when the transmitter is no longer detected. In another embodiment, the system automatically deactivates the light control device after a predetermined period of time. In another embodiment, the transmitter sends another signal to the light control device and, once received, the system automatically deactivates the light control device. In another embodiment, the emergency vehicle operator manually operates the transmitter to send a deactivate signal to the light control device. Through such operation, the light control device may be deactivated either manually or autonomously, thereby returning the traffic lights to their normal operation.

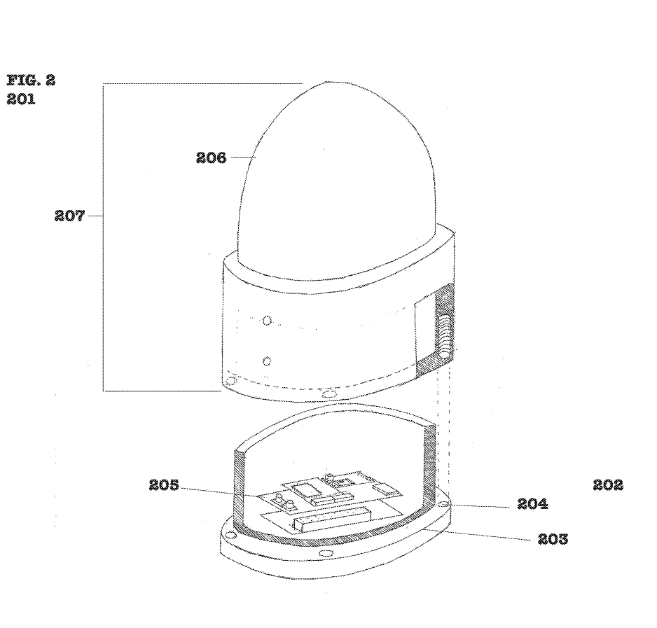

In another exemplary embodiment of the present disclosure and with reference to FIG. 2, the system comprises a safety alerting device 201. The safety alerting device 201 comprises a first housing 207 and a second housing 202. The first housing 207 comprises a beacon 206. The beacon 206 comprises one or more multi-colored lights. In another embodiment, the beacon 206 comprises one or more mono-colored lights. The beacon 206 may illuminate with one or more colors to alert nearby individuals that an emergency vehicle is approaching the traffic light to which the safety alerting device is attached. The beacon 206, the first housing 207, and the second housing 202 are configured such that when installed, the components provide a weather-resistant or weather proof housing that allows the safety alerting device 201 to operate outdoors for prolonged periods. In another embodiment, the second housing 202 comprises a flange 203 and mounting holes 204. The flange 203 and mounting holes 204 are configured such that the safety alerting device 201 may be easily mounted to existing or new traffic lights.

In another exemplary embodiment of the present disclosure, the safety alerting device 201 comprises controller 205. The controller 205 may be located within the safety alerting device and may be connected to one or more traffic lights. The controller 205 may comprise a radio frequency receiver module, a relay, a cellular module, or a geo-locating device. The controller 205 may be configured to control the beacon 206 or an audio indicator. In another embodiment, the controller 205 may connect to a traffic light through one or more wired or wireless networks. The controller 205 may interface with the traffic light and override the traffic light's lighting pattern. For example, once the safety alerting device 201 is activated, the controller 205 may cause traffic lights to display red in all directions. In another embodiment, the controller 205 may cause traffic lights to show green in a particular direction so as to clear traffic in and around the intersection in the direction the emergency vehicle needs to travel.

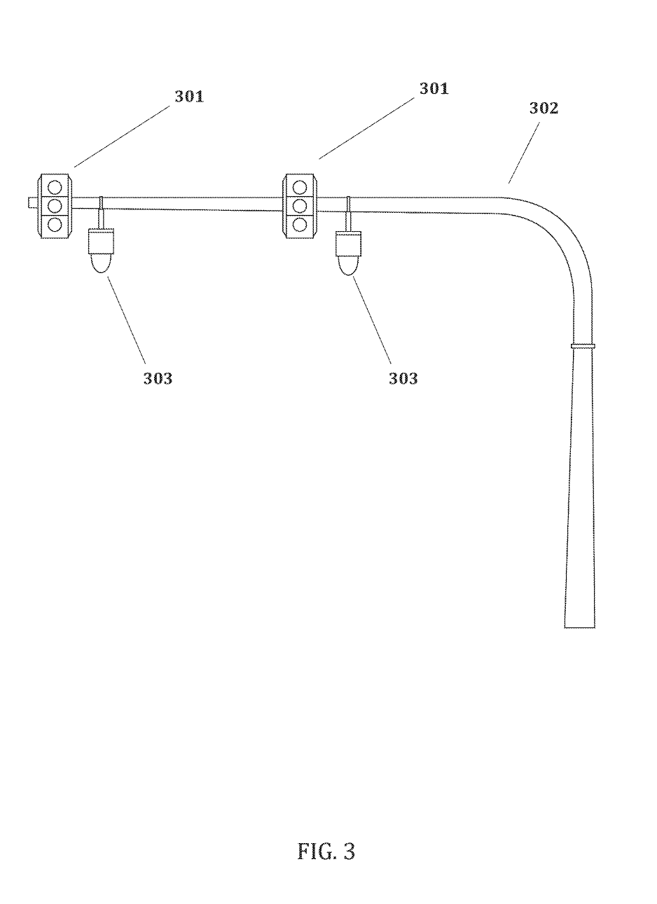

In another exemplary embodiment of the present disclosure and with reference to FIG. 3, the safety alerting device 303 may be used in conjunction with pre-existing traffic light 301. In such an embodiment, the traffic light 301 may be installed onto a traffic light pole 302. The traffic light pole 302 may be pre-existing or new construction. In one embodiment, the safety alerting device 303 may be installed apart from a pre-existing traffic light 304. In another embodiment, the safety alerting device 303 may be directly attached a traffic light 301. In another embodiment, the safety alerting device 303 is user-configurable such that during installation, the safety alerting device 303 may be oriented to facilitate maximum visibility and adaptability.

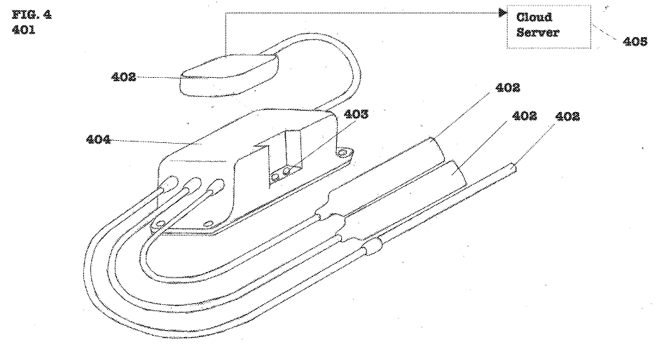

In another exemplary embodiment of the present disclosure and with reference to FIG. 4, the system comprises a transmitter 401 that may be installed into an emergency vehicle. The transmitter 401 may comprise a housing 404, a plurality of antennae 402 including an antenna to interface with a geo-locating device such as global positioning satellites (“GPS”), a radio antenna, a cellular antenna, or another capable of sending and receiving information over one or more wired or wireless networks such as local area network (“LAN”) connection, Bluetooth, infrared, Wi-Fi, cellular LTE, cellular 3G, cellular 4G, and cellular 5G. In another embodiment, the housing 404 may be configured such that the transmitter 401 may be installed into existing emergency vehicles. In another embodiment, the transmitter 401 comprises one or more power connections 403 capable of connecting to and receiving power from the emergency vehicle, a vehicle capacitor, a solar panel, or a photovoltaic power cell. In another embodiment, the transmitter 401 may be configured to operate independent of the emergency vehicle's power. In such an embodiment, the transmitter 401 comprises an internal power supply such as a battery or other power storage device capable of being recharged and power the transmitter 401 for periods of time. In another embodiment, the transmitter 401 comprises a communication antenna 402 that is configured to send and receive data over one or more wired or wireless networks to a server 405. The server 405 may comprise one or more computing and data storage devices capable of communicating with other servers 405 over one or more wired or wireless networks. In one embodiment, the server 405 comprises a cloud server.

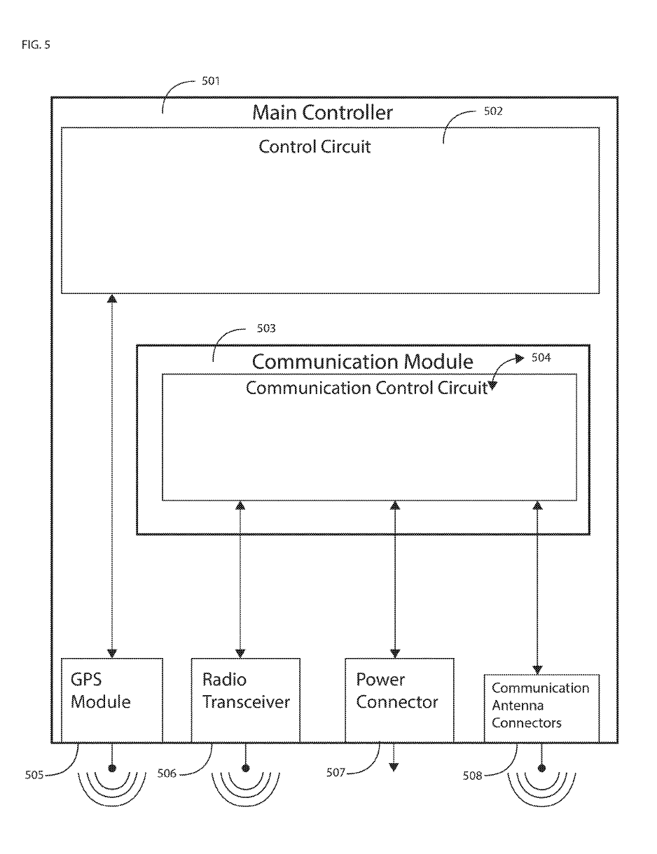

In another exemplary embodiment of the present disclosure and with reference to FIG. 5, the transmitter comprises a main controller 501 comprising a control circuit 502, a communication module 503, a geo-positional locating module 505, a radio transceiver 506, a power connector 507, and a cellular antenna 508. The communication module 503 comprises a communication control circuit 504. The communication control circuit 504 is operably connected to the control circuit 502. The geo-positional locating module 505 may comprise a locating device such as a GPS device. In another embodiment, the geo-positional locating module 505 is configured to operably connect the main controller 501 to an external GPS device. In another embodiment, the power connector 507 is configured such that the main controller 501 may be connected to an external power supply. In another embodiment, the power connector 507 is configured to connect to a power supply from the emergency vehicle into which the main controller 501 is installed. In another embodiment, the power connector 507 may be connected to a power source built into the main controller 501. In another embodiment, the radio transceiver 506 comprises a built-in radio frequency transceiver. In another embodiment, the radio transceiver 506 is configured to be operably connected to an external radio transceiver. In another embodiment, the main controller 501 may comprise a plurality of cellular antennae 508. In one embodiment, the cellular antenna 508 is configured to communicate over one or more wired or wireless networks. In another embodiment, the main controller 501 is configured to be operably connected to an external cellular antenna. In another embodiment, the main controller 501 comprises a built-in cellular antenna 508. The cellular antenna may be configured to interface with one or more wired or wireless networks such as cellular, cellular 3G, cellular 4G, cellular 5G, and Wi-Fi.

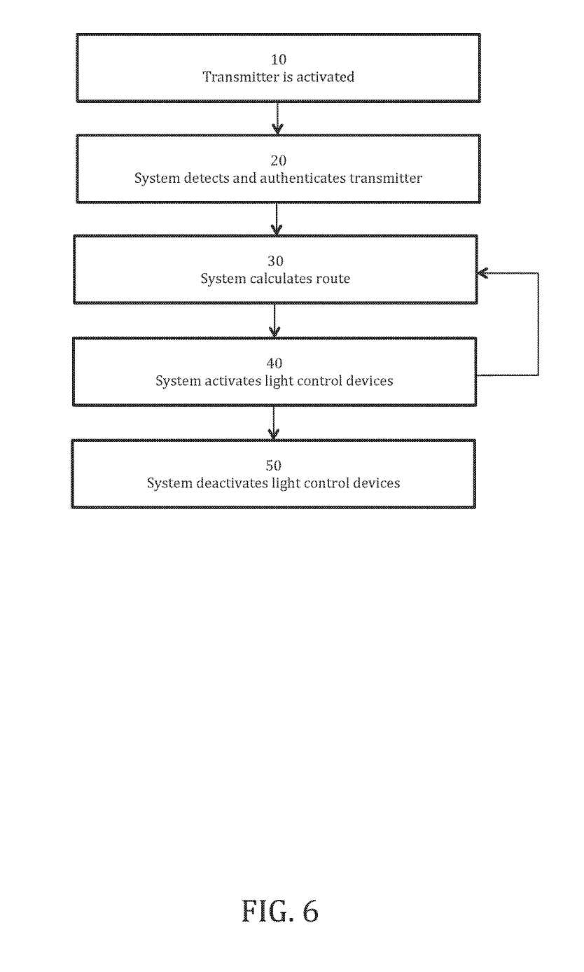

In another exemplary embodiment of the present disclosure and with reference to FIG. 6, in step 10, a transmitter is activated. In one embodiment, the transmitter comprises a device installed in an emergency vehicle capable of transmitting a signal over one or more wired or wireless networks. In another embodiment, the transmitter comprises a low-frequency transmitter capable of transmitting a signal. In another embodiment, the emergency vehicle operator may manually activate the transmitter. In another embodiment, the transmitter may be automatically activated when the emergency vehicle operator activates the vehicle's lights or sirens. In another embodiment the transmitter may be activated remotely by receiving a signal transmitted by the system over one or more wired or wireless networks. In another embodiment, the transmitter, once activated, broadcasts a signal in all directions. In another embodiment, the transmitter broadcasts a signal in the direction the emergency vehicle is traveling. In another embodiment, the transmitter sends a signal to a remote server over one or more wired or wireless networks.

In another exemplary embodiment of the present disclosure and with reference to FIG. 6, in step 20, the system detects and authenticates signals broadcasted by the transmitter. In one embodiment, the transmitter broadcasts a signal comprising an authentication token. In an embodiment, the authentication token may comprise a hashed string of characters the system uses to determine if the signal received emanated from a genuine transmitter. In another embodiment, the authentication token comprises the transmitter's identifying information including the make, model, serial number, manufacture date, and a unit identifier. In another embodiment, the authentication token comprises a hashed string of characters containing the transmitter's identifying information. In another embodiment, the transmitter's identifying information is static. In another embodiment, the transmitter's identifying information is dynamic. In one embodiment, a remote server receives the transmitter's authentication token and authenticates the transmitter. In another embodiment, after the transmitter is authenticated, the system may activate a safety alerting device. In another embodiment, if the transmitter fails authentication, the system may reject the transmitter and prevent it from connecting with the system. In another embodiment, the system records and stores transmitter identifying information relating to transmitters whose connections has been rejected. The system may use this information to determine whether to establish a future connection with a transmitter.

In another exemplary embodiment of the present disclosure and with reference to FIG. 6, in step 30, the system calculates the route for the emergency vehicle. In one embodiment, the emergency vehicle transmits its location to the server. The emergency vehicle's location may be determined by geo-positional data such as GPS. The system also receives the emergency vehicle's desired destination. In one embodiment, the destination is provided by the driver of the emergency vehicle. In another embodiment, the destination is provided by a third-party individual such as a dispatcher or operator. In another embodiment, the destination is provided by third party software. In another embodiment, the system uses the emergency vehicle's location and the destination as arguments. The system calculates the shortest route to the destination. In another embodiment, the system may use real-time traffic information to calculate the quickest route. In one embodiment, the system uses real-time traffic information from third-parties such as GOOGLE MAPS. In another embodiment, the system uses past traffic conditions to predict the quickest route between the emergency vehicle and the destination.

In another exemplary embodiment of the present disclosure and with reference to FIG. 6, in step 40, the system activates safety alerting devices. In one embodiment, the system comprises a safety alerting device attached to each traffic light at an intersection. In such an embodiment, all safety alerting devices communicate with each other over one or more wired or wireless networks. In another embodiment, the system comprises a single safety alerting device with connectivity to all traffic lights in an intersection. In such an embodiment, the safety alerting device may control all traffic lights independent of one another. In another embodiment, the safety alerting device comprises a beacon that alerts near by individuals that an emergency vehicle is approaching the intersection. In one embodiment, the beacon comprises one or more mono-colored lights. In another embodiment, the beacon comprises one or more multi-colored lights. In another embodiment, the system comprises an audio indicator. The audio indicator may emit mono- or multi-tonal sound that indicates that an emergency vehicle is approaching the intersection to near by people. In another embodiment, the system may comprise one or more safety alerting devices installed locally at a particular intersection. In another embodiment, the system may comprise one or more safety alerting devices that may be stored remotely. In such an embodiment, the remotely-located safety alerting devices are configured to communicate with traffic lights over one or more wired or wireless networks.

In another embodiment of the present disclosure, once activated, the system may cause all traffic lights in an intersection to display red lights so that traffic will not enter the intersection. In another embodiment, once activated, the system may activate the beacon comprising one or more lights. In another embodiment, the beacon comprises a lighted sign with words or figures indicative of emergency vehicles. In such an embodiment, for example, the beacon may comprise the words “EMERGENCY VEHICLE APPROACHING,” or “CLEAR INTERSECTION.” In another embodiment, once activated, the system may cause the traffic lights to direct traffic to continue in the direction the emergency vehicle is moving. For example, if a north-bound emergency vehicle approaches an intersection comprising an east-west street, the system may cause the traffic directing east-bound, west-bound, and south-bound traffic to stop while directing the north-bound traffic to proceed north. The system may direct north-bound traffic to continue north to alleviate north-bound traffic congestion thereby allowing the emergency vehicle to proceed north unimpeded. In another embodiment, the system may calculate the emergency vehicle's path of travel and activate safety alerting devices along that route. In such an embodiment, the system may comprise a visual readout that displays the protected route to the emergency vehicle's driver. In another embodiment, the emergency vehicle's driver may specify a particular route to be protected by one or more safety alerting devices. In another embodiment, the transmitter may be detected by multiple safety alerting devices located at multiple intersections. In such an embodiment, the system may activate one or more of the safety alerting devices detecting the transmitter.

In another embodiment, the system may use the emergency vehicle's calculated route and activate all safety alerting devices along that route. In another embodiment, the system may recalculate the emergency vehicle's route on a predetermined interval to ensure the calculated route is the quickest in light of changing traffic conditions. The system may use input from the transmitter or the emergency vehicle's operator to recalculate the route.

In another exemplary embodiment of the present disclosure, the safety alerting device, once activated, may also emit a signal to be detected by other mobile devices. In such an embodiment, the safety alerting device may emit a signal that is detected by other mobile devices within a pre-determined range. When those mobile devices detect the signal emitted by the safety alerting device, the device alert their owners to the eminent presence of an emergency vehicle, thereby allowing those people to clear the intersection before the emergency vehicle arrives at the intersection.

In another exemplary embodiment of the present disclosure and with reference to FIG. 6, in step 50, the system deactivates the light control device after the emergency vehicle exits the intersection. In one embodiment, the system automatically deactivates the light control device when the transmitter is no longer detected. In another embodiment, the system automatically deactivates the light control device after a predetermined period of time. In another embodiment, the transmitter sends another signal to the light control device and, once received, the system automatically deactivates the light control device. In another embodiment, the emergency vehicle operator manually operates the transmitter to send a deactivate signal to the light control device. Through such operation, the light control device may be deactivated either manually or autonomously, thereby returning the traffic lights to their normal operation.

The invention has been described herein using specific embodiments for the purposes of illustration only. It will be readily apparent to one of ordinary skill in the art, however, that the principles of the invention may be embodied in other ways. Therefore, the invention should not be regarded as being limited in scope to the specific embodiments disclosed herein, but instead as being fully commensurate in scope with the following claims and figures.

I claim:

1. A safety alerting device comprising:
a. a beacon;
b. a transceiver for receiving information over one or more networks; and
c. a traffic light communicator for communicating with one or more traffic lights, wherein the safety alerting device is operable to alter the illumination pattern of one or more traffic lights, wherein the beacon is operable to alert one on more individuals of an emergency vehicle, and wherein the beacon is selected from the group consisting of a plurality of single-colored lights, a plurality of multi-colored lights, a an audible siren, and a combination thereof.

2. The safety alerting device of claim 1, further comprising a power cell, wherein the power cell comprises a solar panel or photovoltaic panel used to power the safety alerting device; wherein the power cell is removable; and wherein the power cell is user-positionable.

3. The safety alerting device of claim 1, wherein the transceiver is operable to send information over one or more networks.

4. The safety alerting device of claim 1, further comprising a vehicle transmitter for transmitting information to the safety alerting device over one or more networks.

5. The safety alerting device of claim 4, wherein the vehicle transmitter is operable for transmitting an authentication token; and wherein the safety alerting device is operable for authenticating the authentication token before accepting information.

6. The safety alerting device of claim 4, wherein the vehicle transmitter further comprises a vehicle display being operable to display traffic information to vehicle operators.

7. The safety alerting device of claim 1, wherein the transceiver is operable to send information to and receive information from a server over one or more networks.

8. The safety alerting device of claim 3, further comprising
a. a user mobile device for sending and receiving information over one or more networks comprising a mobile device display; and
b. an app loaded on the user mobile device; wherein the user mobile device is operable to receive information from the transceiver; and wherein the app causes the user mobile device to display an alert on the mobile device display.

9. A system for alerting comprising:
a. a beacon for alerting individuals of approaching emergency vehicles;
b. a transceiver for receiving, from one or more sources, information relating to approaching emergency vehicles; and
c. a traffic light communicator for altering the illumination pattern of one or more traffic lights.

10. The system of claim 9, wherein the transceiver is operable for sending information over one or more networks.

11. The system of claim 9, further comprising a server, wherein the server is operable to receive information from the transceiver, over one or more networks; and wherein the server is operable to send information to the transceiver, over one or more networks.

12. The system of claim 9, which further comprises means for calculating a vehicle route.

13. The system of claim 12, wherein calculating a vehicle route further includes receiving information relating to traffic conditions.

14. The system of claim 10, further comprising
a. a user mobile device for sending and receiving information over one or more networks comprising a mobile device display; and
b. an app loaded on the user mobile device, wherein the user mobile device is operable to receive information from the transceiver in connection with the app causing the user mobile device to display an alert on the mobile device display.

15. The system of claim 9, further comprising a vehicle transmitter operable for sending information over one or more networks.

16. The system of claim 15, wherein the vehicle transmitter includes an authentication token.

17. The system of claim 16, wherein
a. the transceiver is operable to connect to the vehicle transmitter in connection with the authentication token being authenticated; and
b. the transceiver is operable to disconnect from the vehicle transmitter in connection with the authentication not being authenticated.
